(19) United States
(12) Patent Application Publication
(10) Pub. No.: US 2017/0295600 A1
(43) Pub. Date: Oct. 12, 2017

(54) Tethering Policy for Network Connectivity via a Tethered Connection

(71) Applicant: Microsoft Technology Licensing, LLC, Redmond, WA (US)

(72) Inventor: Amer Aref Hassan, Kirkland, WA (US)

(21) Appl. No.: 15/096,040

(22) Filed: Apr. 11, 2016

(51) Int. Cl. H04W 76/02; H04L 29/06; H04L 29/08

(52) U.S. Cl. CPC H04W 76/023; H04L 67/1063; H04L 63/20; H04W 88/04

(57) ABSTRACT

Techniques for tethering policy for network connectivity via a tethered connection are described. According to one or more embodiments, tethering policies are enforced to enable a tethered connection between a guest device and a host device for providing network connectivity to the guest device.

### BACKGROUND

Many devices today utilize some form of wireless radio frequency (RF) data communication. Examples of wireless RF communication include cellular networks (e.g., for cell phones), data broadband (e.g., Wi-Fi®), broadcast television, global positioning system (GPS) navigation, and so forth. Wireless RF communication can be leveraged for various purposes, such as for communicating voice data, video data, application data, and so forth.

Situations arise where a particular client device is unable to establish a direct wireless connection to a network, such as the Internet. However, the client device may connect to a different client device that does have network connectivity, and the different client device can serve as a network access point for the particular client device. Such arrangements are typically referred to as “tethering,” where a peer-to-peer connection between client devices enables one device to provide network connectivity to another device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for tethering policy for network connectivity via a tethered connection are described. According to one or more embodiments, tethering policies are enforced to enable a tethered connection between a guest device and a host device for providing network connectivity to the guest device.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein in accordance with one or more implementations.

FIG. 2 illustrates an example implementation of tethering policies in accordance with one or more implementations.

FIG. 3 illustrates an example implementation scenario for providing a tethered connection in accordance with one or more implementations.

FIG. 4 illustrates an example implementation scenario for providing a tethered connection in accordance with one or more implementations.

FIG. 5 is a flow diagram that describes steps in a method for determining parameters for a tethering connection in accordance with one or more implementations.

FIG. 6 is a flow diagram that describes steps in a method for determining parameters for a tethering connection in accordance with one or more implementations.

FIG. 7 is a flow diagram that describes steps in a method for brokering network connectivity via a tethering connection in accordance with one or more implementations.

FIG. 8 illustrates an example system and computing device as described with reference to FIG. 1, which are configured to implement embodiments of techniques described herein.

### DETAILED DESCRIPTION

Overview

Techniques for tethering policy for network connectivity via a tethered connection are described. Generally, “tethering” refers to connection of a guest device to a host device to enable the host device to provide wireless connectivity to the guest device. For instance, a host device may directly and/or indirectly provide Internet and/or other network connectivity to a guest device. In at least some implementations, both a host device and a guest device are end-user devices.

As an example implementation scenario, consider that a first mobile device (a “host device”) (e.g., a smartphone, a tablet, a laptop, and so forth) is connected to a network via a wireless connection, such as via a cellular data connection, data broadcast over TV whitespaces, broadcast over available guard bands, and so forth. Consider further that a second mobile device (a “guest device”) is in close proximity to the host device. The mobile devices, for instance, may be in the same room, such as a conference room, a classroom, and so forth. According to one or more implementations, the guest device can wirelessly connect to the host device to establish a tethered connection between the devices.

To enable network connectivity to be provided to the guest device via the host device, one or more tethering policies are applied. The tethering policies, for instance, specify various conditions and parameters for providing network connectivity to the guest device via a tethered connection. Consider, for instance, that a tethering policy specifies that the network to which the host device is connected is not a preferred network for the guest device. Consider further that the host device is in proximity to a different host device that is connected to a preferred network. Accordingly to techniques described herein, the host device can establish a direct peer-to-peer connection (e.g., a tethered connection) to the different host device. Accordingly, network connectivity to the preferred network can be provided to the guest device via the interconnectivity between the host device, the different host device, and the guest device.

According to one or more implementations, a tethering service is employed to ascertain whether tethering connections are permitted, and to enforce various security-related policies for tethering devices. For instance, when a guest device requests to tether to a host device for network connectivity, the tethering service is queried to ascertain whether the tethering connection is permitted. Generally, the tethering service may determine whether the tethering connection is permitted based on various parameters, such as device type of the host device, network type of a network to which the host device is connected, and so forth. Further, the tethering service may enable various tethering policies to be provisioned to a host device. In at least some implementations, a tethering policy includes security parameters and/or procedures to be enforced as part of a tethering connection.

Accordingly, techniques for tethering policy for network connectivity via a tethered connection can be implemented to provide secure high-quality network connectivity to a tethered guest device.

In the following discussion, an example environment is first described that is operable to employ techniques described herein. Next, a section entitled “Example Implementation Scenarios” describes some implementation scenarios involving techniques discussed herein which may be employed in the example environment as well as in other environments. Following this, a section entitled “Example Procedures” describes some example procedures for tethering policy for network connectivity via a tethered connection in accordance with one or more embodiments. Finally, a section entitled “Example System and Device” describes an example system and device that are operable to employ techniques discussed herein in accordance with one or more embodiments.

### Example Environment

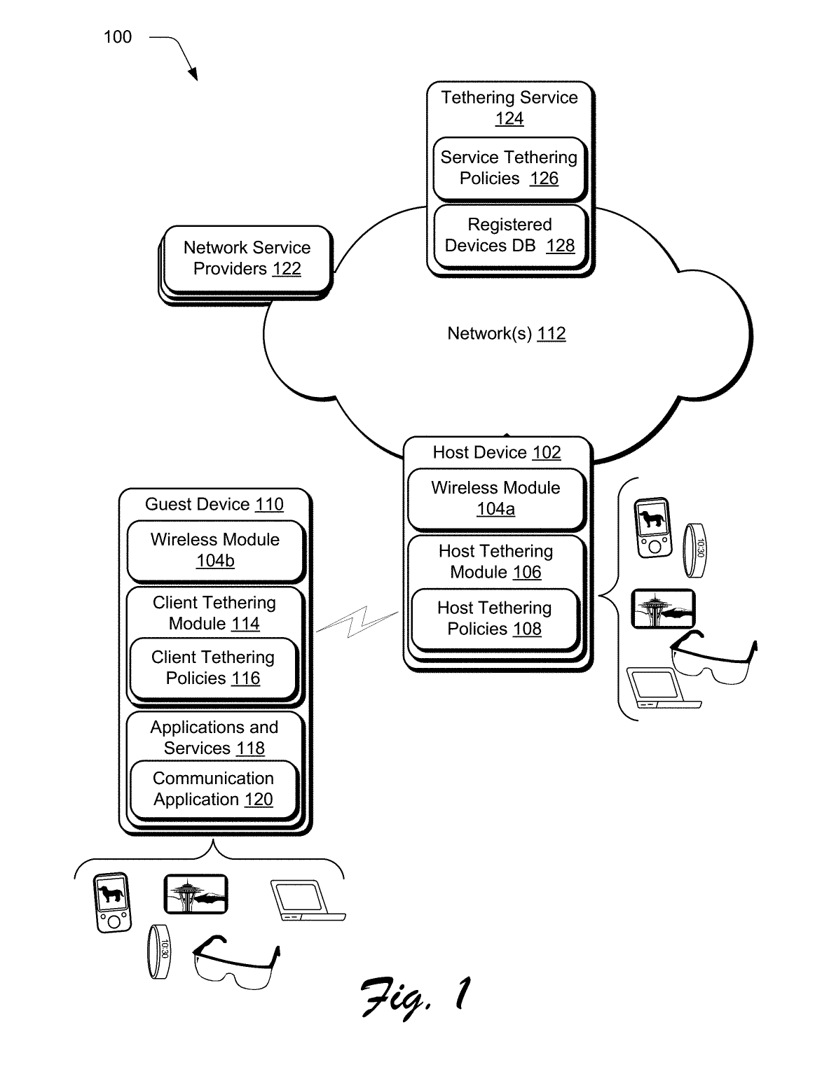

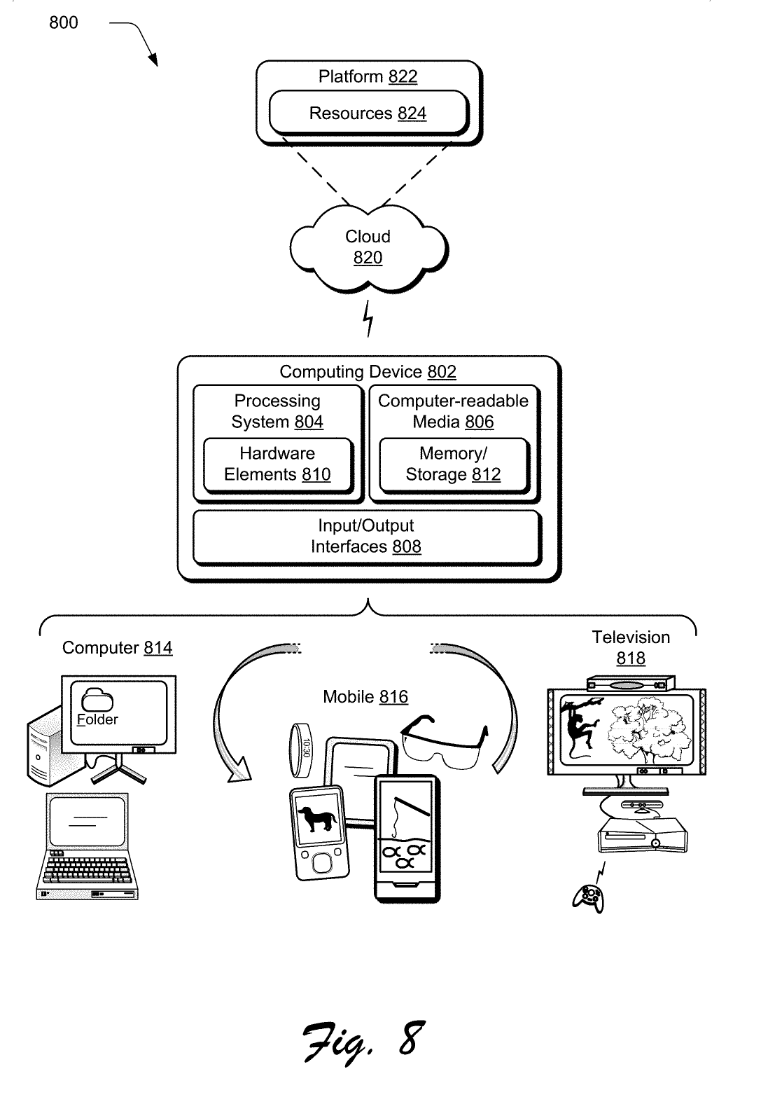

FIG. 1 is an illustration of an environment 100 in an example implementation that is operable to employ techniques for tethering policy for network connectivity via a tethered connection. Environment 100 includes a host device 102 which can be embodied as any suitable device such as, by way of example and not limitation, a smartphone, a wearable device, a tablet computer, a portable computer (e.g., a laptop), a desktop computer, and so forth. One of a variety of different examples of the host device 102 is shown and described below in FIG. 8.

The host device 102 is illustrated as including a wireless module 104a, which is representative of functionality to enable the host device 102 to communicate wirelessly with other devices and/or entities. The wireless module 104a can be configured to enable data communication via a variety of different wireless techniques and protocols. Examples of such techniques and/or protocols include cellular communications (e.g. 3G, 4G, Long Term Evolution (LTE), and so forth), near field communication (NFC), short-range wireless connections (e.g., Bluetooth), local area wireless networks (e.g., one or more standards in compliance with IEEE 802.11), wide area wireless networks (e.g., one or more standard in compliance with IEEE 802.16), wireless telephone networks, and so on.

The wireless module 104a, for instance, includes hardware components that can be employed to enable the host device 102 to communicate wirelessly. Examples of such wireless hardware components include radio transmitters, radio receivers, various types and/or combinations of antennas, and so on. In at least some embodiments, the host device 102 is a multi-radio device that can communicate via different wireless technologies and/or protocols.

The host device 102 further includes a host tethering (“host”) module 106 that maintains host tethering policies (“host policies”) 108. The host module 106 is representative of functionality to enable a guest device 110 to wirelessly “tether” to the host device 102 such that wireless resources, such as access to networks 112, can be provided to the guest device 110 via the host device 102. The host module 106, for instance, enables various aspects of techniques for tethering policy for network connectivity via a tethered connection to be performed.

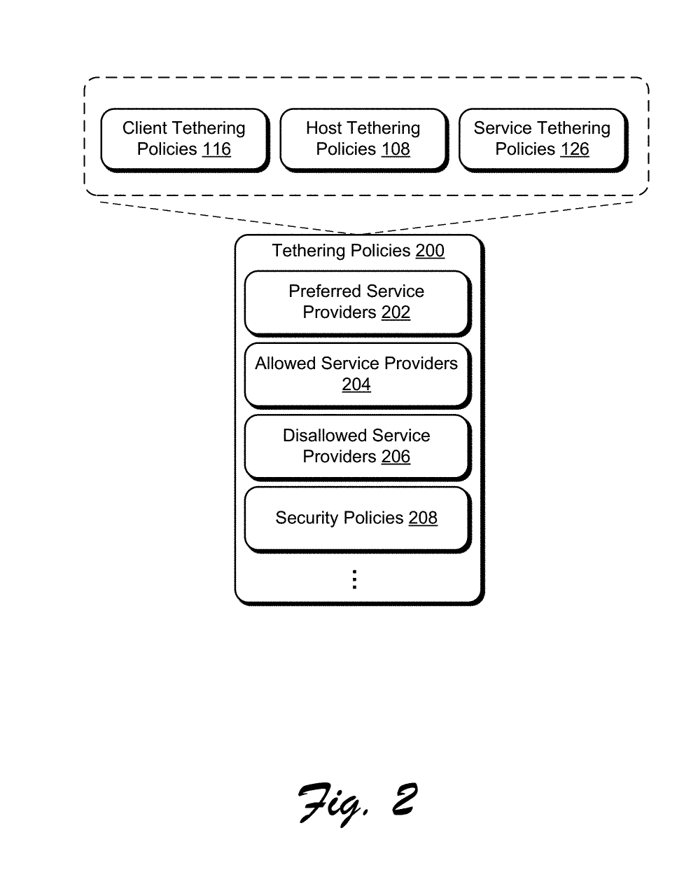

The host policies 108 are representative of different rules and parameters for providing tethering service to the guest device 110. Further details concerning the host policies 108 are discussed below with reference to FIG. 2.

The guest device 110 is representative of a device that wirelessly connects (“tethers”) to the host device 102 such that wireless resources are routed through the host device 102 to the guest device 110. The guest device 110, for instance, accesses the networks 112 via the host device 102. The guest device 110 can be embodied as any suitable device such as, by way of example and not limitation, a smartphone, a tablet computer, a wearable device, a portable computer (e.g., a laptop), a desktop computer, and so forth. One of a variety of different examples of the guest device 110 is shown and described below in FIG. 8. Although a single guest device 110 is illustrated, it is to be appreciated that implementations enable multiple devices to tether to the host device 102 such that wireless resources can be routed (e.g., simultaneously and/or concurrently) through the host device 102 to multiple different tethered devices.

The guest device 110 includes a client tethering (“client”) module 114, which is representative of functionality to enable the guest device 110 to establish and manage a tethering connection with another device, such as the host device 102. The client module 114 maintains client tethering (“client”) policies 116, which are representative of different rules and policies for establishing and/or participating in a tethering connection. In at least some implementations, the guest device 110 pushes one or more of the client policies 116 to the host device 102, which uses the client policies 116 to populate the host policies 108.

According to various implementations, the networks 112 are representative of different interconnected networks. The networks 112 may also represent a combination of wireless and wired networks and may be configured in a variety of ways, such as a wide area network (WAN), a local area network (LAN), the Internet, and so forth.

The guest device 110 includes a wireless module 104b, which is representative of functionality to enable guest device 110 to communicate wirelessly with other devices and/or entities. Example attributes of the wireless module 104b are discussed above with reference to the wireless module 104a.

The guest device 110 further includes applications and services (“apps”) 118, which are representative of functionalities to perform various tasks via the guest device 110. As used herein, the term “applications” can refer to applications that are run locally and/or in a distributed environment, as well as services such as local services, web services, cloud-based services, and so forth. Examples of the apps 118 include a word processing application, a web browser, an email client, a communication service, a spreadsheet application, a content editing application, a web-based service portal, and so forth.

The apps 118, for instance, include a communication application 120. Generally, the communication application 120 is representative of functionality to enable different forms of communication via the guest device 110. Examples of the communication application 120 include a voice communication application (e.g., a Voice over Internet Protocol (VoIP) client), a video communication application, a messaging application, a content sharing application, and combinations thereof. The communication application 120, for instance, enables different communication modalities to be combined to provide diverse communication scenarios. In at least some implementations, the communication application 120 may be implemented as an application installed on the guest device 110, and/or as a portal to a communication service that is hosted remotely and accessible via the networks 112.

The environment 100 further includes network service providers (“service providers”) 122 and a tethering service 124. The service providers 122 are representative of entities that provide network infrastructure and connectivity for the networks 112 via different networking technologies. Examples of the service providers 122 include cellular service providers, Internet service providers (ISPs), enterprise and/or facility network providers, and so forth. According to various implementations, the service providers 122 can provide network connectivity to the host device 102 via one or more of a variety of different wireless technologies, such as cellular (e.g., LTE, 3G, and so forth), Wi-Fi™, television white spaces, satellite, and so forth.

The tethering service 124 is representative of network-based functionality to perform various aspects of techniques for tethering policy for network connectivity via a tethered connection discussed herein. In at least some implementations, the tethering service 124 represents a cloud-based service that is accessible to the host device 102 to assist the host device 102 in performing various tethering-related tasks. The tethering service 124 maintains service tethering policies (“service polices”) 126, which represent different rules and parameters for providing tethering services to various client devices. In at least some implementations, the service policies 126 can be used to provision and/or update the host policies 108 on the host device 102.

In at least some implementations, the tethering service 124 provides registration and authorization functionality for tethering connections. For instance, the tethering service 124 can register the host device 102 for hosting a tethering connection, and register the guest device 110 for receiving a tethering connection. Further, the tethering service 124 can ascertain whether a particular tethering connections is authorized, such as based on whether particular devices involved are permitted to engage in a tethering relationship. Accordingly, the tethering service 124 maintains a registered devices database (“devices DB”) 128, which tracks devices that are registered to provide and/or receive tethering services.

According to various implementations, a peer-to-peer connection between the host device 102 and the guest device 110 can be established utilizing a variety of different wireless data communication techniques and/or protocols, such as Wi-Fi Direct™, Bluetooth, and so on.

FIG. 2 illustrates an example implementation of tethering policies 200, which represent implementations of one or more of the client policies 116, the host policies 108, and/or the service policies 126.

The tethering policies 200 include preferred service providers 202, allowed service providers 204, and disallowed service providers 206. Generally, the preferred service providers 202 identify different network service providers 122 whose networks are consider preferred for providing network connectivity to a tethered device. The allowed service providers 204 identify different network service providers 122 whose networks are permitted to be used to provide network connectivity to a tethered device, but whose networks are not preferred. As further detailed below, if both a preferred network and an allowed network are available for providing network connectivity to a tethered device, the preferred network will typically be selected.

The disallowed service providers 206 identify different network service providers 122 whose networks are not permitted to be used to provide network connectivity to a tethered device. A network service provider may be identified in the disallowed service providers 206 based on various criteria, such as the network service provider not being trusted, being known to have unsecure networks, where usage of the service provider is contrary to a business agreement and/or business relationship, and so forth.

The tethering policies 200 further include security policies 208, which represent different security-related permissions and procedures for tethering connections. The security policies 208, for instance, may specify security procedures to be used for establishing and/or participating in a tethered connection. In at least some implementations, the security policies 208 may specify a particular encryption technique to be employed by a tethered device for encrypting and/or decrypting data transmitted over a tethering connection. For instance, the security policies 208 may include encryption keys (e.g., a public key) to be used for encrypting data. Further, particular security policies 208 may be network-specific and/or device-specific. For instance, the security policies 208 may specify a more robust encryption technique be used for a tethered connection to an unknown and/or untrusted device and/or network than would be used for a known trusted network.

Having described an example environment in which the techniques described herein may operate, consider now a discussion of some example implementation scenarios in accordance with one or more embodiments.

### Example Implementation Scenarios

The following discussion describes example implementation scenarios for tethering policy for network connectivity via a tethered connection in accordance with one or more embodiments. In portions of the following discussion, reference will be made to the environment 100 of FIG. 1.

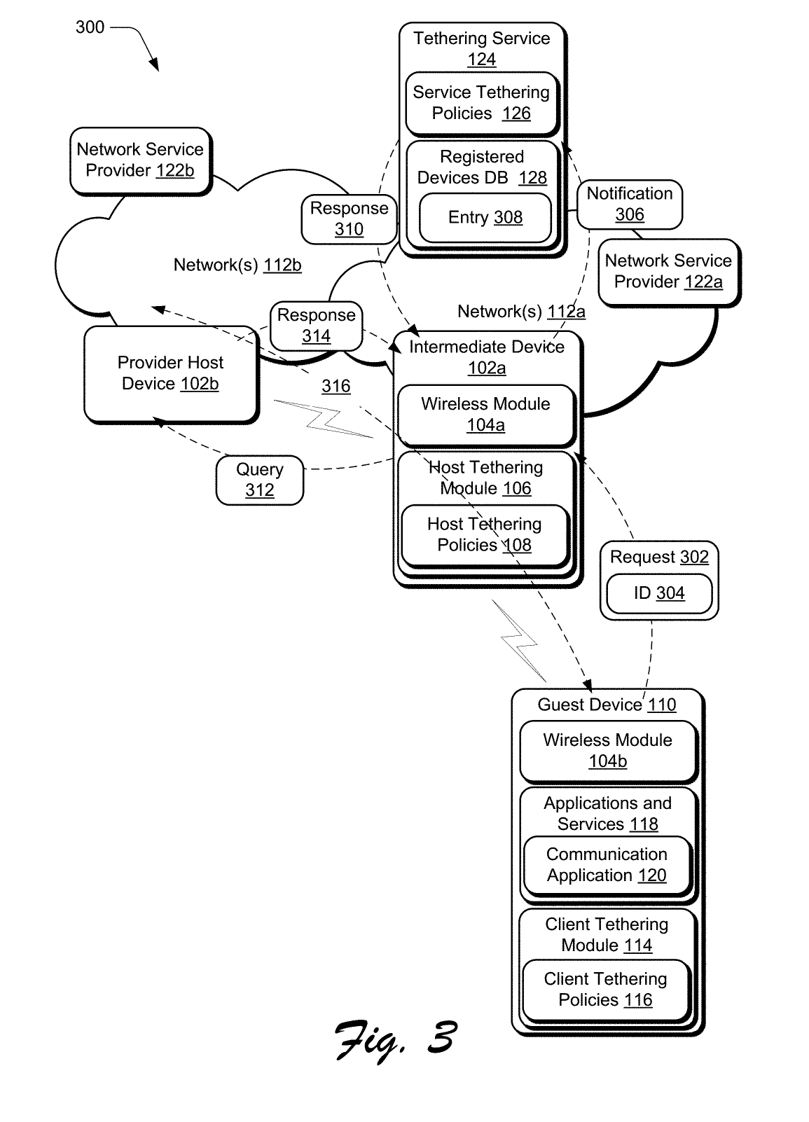

FIG. 3 illustrates an example implementation scenario 300 for providing a tethered connection in accordance with one or more embodiments. The scenario 300 includes the guest device 110, an intermediate host device (“intermediate device”) 102a, and a provider host device (“provider device”) 102b. Generally, the intermediate device 102a and the provider device 102b represent instances of the host device 102 introduced above. The intermediate device 102a is connected to a network 112a that is deployed and/or managed by a service provider 122a, and the provider device 102b is connected to a network 112b that is deployed and/or managed by a service provider 122b. According to various implementations, the networks 112a, 112b represent different instances of the networks 112, and the service providers 122a, 122b represent different instances of the service providers 122.

In the scenario 300, the guest device 110 does not have direct network connectivity, such as to one of the networks 112a, 112b. For instance, the guest device 110 does not have a service agreement and/or authentication information that allows the guest device 110 to directly connect to one of the networks 112a, 112b. Alternatively or additionally, the guest device 110 does not support a wireless technology used to implement the networks 112a, 112b.

The guest device 110, however, detects that the intermediate device 102a is available to broker a wireless network connection for the guest device 110. The guest device 110, for example, detects wireless transmission from the intermediate device 102a, such as a wireless beacon, transmission as part of a wireless communication, and so forth. Accordingly, the guest device 110 communicates a tethering request 302 to the intermediate device 102a via the client module 114. The tethering request 302 includes various information about the guest device 110, such as an ID 304 for the guest device 110 (e.g., a user ID, a device ID, and so forth), identifiers for one or more of the apps 118, attributes (e.g., bandwidth) of a wireless connection being requested, and so forth.

Based on the tethering request 302, the guest device 110 wirelessly associates (e.g., “tethers”) to the intermediate device 102a. The guest device 110, for instance, establishes a direct wireless connection with the intermediate device 102a.

In at least some implementations, the tethering request 302 includes a client policy 116 that is to be used by the host device 102 to broker network connectivity for the guest device 110. The host policies 108, for instance, are provisioned using a client policy 116 received from the guest device 110.

Alternatively or additionally, the host policies 108 are provisioned by the tethering service 124. For instance, in response to the tethering request 302, the host module 106 submits a tethering notification 306 that includes the ID 304 to the tethering service 124. The tethering service 124 uses the ID 304 as part of a lookup to identify an entry 308 in the devices DB 128 for the guest device 110. Generally, the entry 308 specifies that the guest device 110 is permitted to tether to certain devices subject to the service policies 126. Accordingly, the tethering service 124 communicates a tethering response 310 that includes one or more of the service policies 126 to the intermediate device 102a. The host module 106 can use the service policies 126 received with the tethering response 310 to provision the host policies 108. Thus, according to techniques for tethering policy for network connectivity via a tethered connection, tethering policies may be defined and provisioned by various entities.

Continuing with the scenario 300, the host module 106 applies the host policies 108 to determine conditions for providing a network connection to the guest device 110. In this particular implementation, the host policies 108 indicate that the network 112a is not a preferred network and/or that the network 112a is a disallowed network. For instance, the service provider 122a is not identified in the preferred service providers 202, and/or is identified in the disallowed service providers 206.

The intermediate device 102a, however, detects that the provider device 102b is available to provide network connectivity to the network 112b. For instance, the intermediate device 102a communicates a tethering query 312 to the provider device 102b requesting information about the provider device 102b. The tethering query 312, for example, queries for network information for the network 112b, such as a network identifier and/or an identifier for the service provider 122b. The provider devices 102b returns a response 314 that identifies the provider device 102b, the network 112b, and/or the service provider 122b. Accordingly, the host module 106 ascertains that the network 112b is preferred over the network 112a for providing network connectivity to the guest device 110. The service provider 122b, for instance, is identified in the preferred service providers 202 and/or the allowed service providers 204.

Further to the scenario 300, the intermediate device 102a establishes a tethered connection to the provider device 102b, and a network connection 316 to the network 112b is provided to the guest device 110. The network connection 316, for instance, is implemented over the tethered connection between the provider device 102b and the intermediate device 102a, and the tethered connection between the intermediate device 102a and the guest device 110. Generally, the network connection 316 provides the guest device 110 with connectivity to various networks and/or services, such as the Internet.

In at least some implementations, a host policy 108 can include certain security procedures to be implemented for a tethering connection between the guest device 110 and the intermediate device 102a. For instance, a host policy 108 can include a security policy 208 that specifies a certain encryption type and/or encryption key to be used by the guest device 110 for encrypting data transmitted over a tethered connection. Thus, the intermediate device 102a can notify the guest device 110 to implement the specified security procedure(s) when transmitting data over the network connection 316.

Accordingly, the scenario 300 illustrates that various policy-based considerations can be employed to provide network connectivity via a tethered connection.

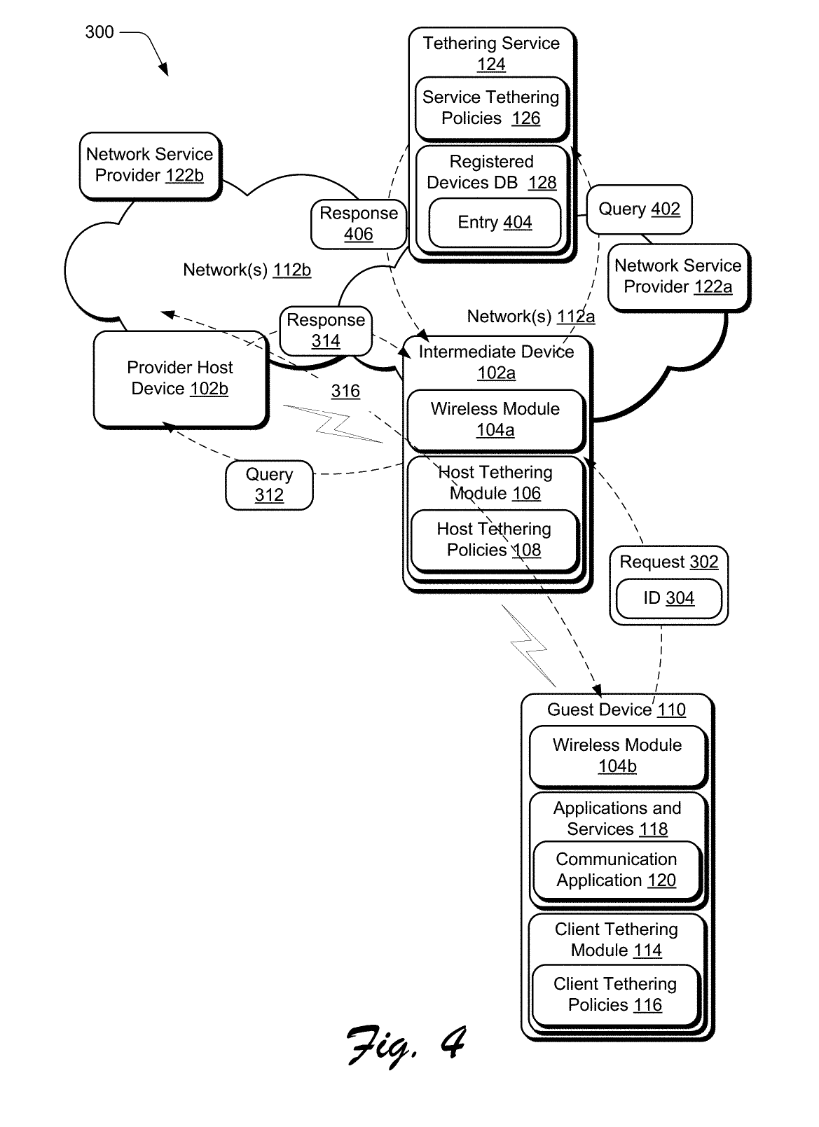

FIG. 4 illustrates an example implementation scenario 400 for providing a tethered connection in accordance with one or more embodiments. The scenario 400, for instance, represents a variation on the scenario 300 discussed above.

In the scenario 400, the guest device 110 does not have direct network connectivity, such as to one of the networks 112a, 112b. Accordingly, the guest device 110 communicates the tethering request 302 to the intermediate device 102a as described above. In response to receiving the tethering request 302, the intermediate device 102a communicates a tethering query 402 to the tethering service 124. Generally, the tethering query 402 notifies the tethering service 124 that the guest device 110 is requesting to tether to the intermediate device 102a for purposes of network connectivity. The tethering service 124 performs a lookup in the devices DB 128 to identify an entry 404 for the guest device 110.

Generally, the entry 404 indicates conditions under which the guest device 110 is or is not permitted to establish a tethering connection to another device. For instance, the entry 404 identifies certain device types/device instances that the tethered device is/is not permitted to tether to. Some device types/device instances may be unknown and/or untrusted, and thus in the interest of device safety the guest device 110 may be prevented from tethering from such devices. As another example, the entry 404 specifies that if a host device (e.g., the intermediate device 102a) is connected to certain network types/network instances, the guest device 110 is/is not permitted to tether to the host device. Some network types/network instances may be unknown and/or untrusted, and thus in the interest of device safety the guest device 110 may be prevented from tethering to devices connected to such networks.

Continuing with the scenario 400, the entry 404 indicates that the guest device 110 is permitted to tether to the intermediate device 102a. Accordingly, the tethering service 124 returns a tethering response 406 to the intermediate device 102a. The tethering response 406 generally specifies that the guest device 110 is permitted to tether to the intermediate device 102a. In at least some implementations, the tethering response 406 also includes one or more service policies 126 to be utilized in providing network connectivity to the guest device 110 via a tethered connection. The scenario 400 then proceeds similarly to the scenario 300 in that the network connection 316 is established as described above and via the tethered connection between the provider device 102b and the intermediate device 102a, and the tethered connection between the intermediate device 102a and the guest device 110.

Accordingly, the scenario 400 illustrates that the tethering service 124 may be leveraged as a permissions service to ascertain whether tethering connections are permitted in difference scenarios.

Having discussed some example implementation scenarios, consider now some example procedures in accordance with one or more embodiments.

### Example Procedures

The following discussion describes some example procedures for tethering policy for network connectivity via a tethered connection in accordance with one or more embodiments. The example procedures may be employed in the environment 100 of FIG. 1, the system 800 of FIG. 8, and/or any other suitable environment. The procedures, for instance, represent example procedures for performing the implementation scenarios described above. In at least some embodiments, the steps described for the various procedures can be implemented automatically and independent of user interaction.

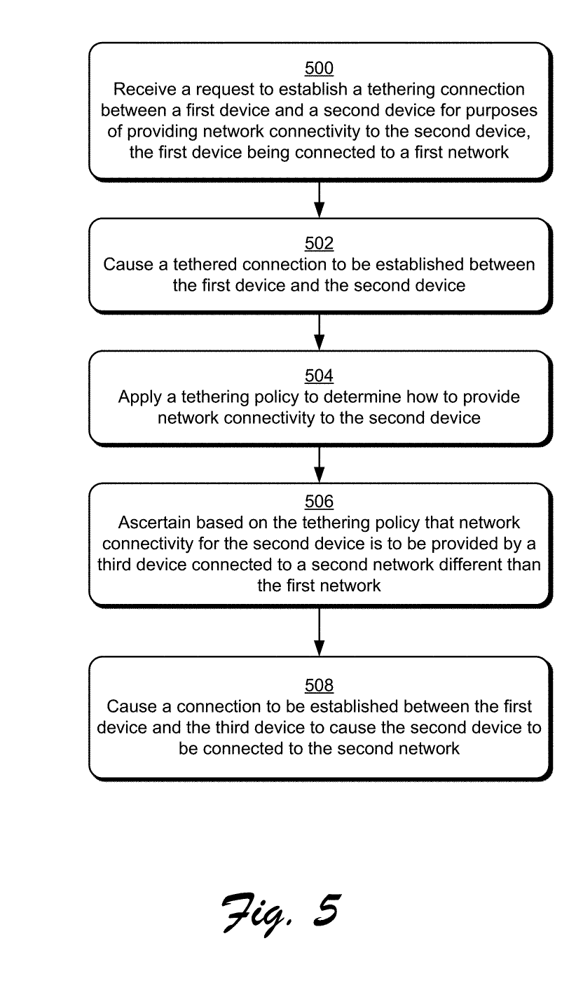

FIG. 5 is a flow diagram that describes steps in a method for determining parameters for a tethering connection in accordance with one or more implementations. In at least some implementations, the method can be performed by the host device 102, the tethering service 124, and/or interaction between the host device 102 and the tethering service 124.

Step 500 receives a request to establish a tethering connection between a first device and a second device for purposes of providing network connectivity to the second device, the first device being connected to a first network. For instance, the intermediate device 102a receives a request from the guest device 110 to establish a tethering connection for providing network connectivity. In at least some implementations, the request includes various information, such as an ID for the guest device 110 and various parameters for providing network connectivity via a tethered connection. The request, for instance, includes a tethering policy 200.

Step 502 causes a tethered connection to be established between the first device and the second device. For instance, the guest device 110 and the intermediate device 102a negotiate a direct peer-to-peer connection for tethering the guest device 110 to the intermediate device 102a.

In at least some implementations, forming a tethered connection includes ascertaining whether the tethered connection is permitted. For instance, the intermediate device queries the tethering service 124 with an indication that the guest device 110 is requesting to tether to the intermediate device 102a. The intermediate device 102a receives a notification from the tethering service 124 indicating whether the second device is permitted to tether to the intermediate device 102a.

Step 504 applies a tethering policy to determine how to provide network connectivity to the second device. For instance, the intermediate device 102a compares information about its environment to a host policy 108 to determine how to provide network connectivity to the guest device 110. Examples of such environmental information include identifiers for the networks 112a, 112b, identifiers for the service providers 122a, 122b, network conditions for the networks 112a, 112b, and so forth.

Alternatively or additionally, the tethering service 124 applies a service policy 126 to ascertain parameters for providing network connectivity to the guest device 110, such as based on environmental conditions known to the tethering service 124.

Step 506 ascertains based on the tethering policy that network connectivity for the second device is to be provided by a third device connected to a second network different than the first network. The intermediate device 102a, for instance, determines that a host policy 108 indicates that the network 112b is preferred over the network 112a for providing network connectivity.

Step 508 causes a connection to be established between the first device and the third device to cause the second device to be connected to the second network. Network connectivity to the second network, for example, is implemented via the tethered connection between the first device and the second device, and the connection between the first device and the third device. For instance, with reference to the scenarios 300, 400, the network connection 316 is established to connect the guest device 110 to the network 112b.

In at least some implementations, the intermediate device 102a negotiates a direct peer-to-peer connection with the provider device 102b. Intermediate device 102a, for example, establishes a tethering connection to the provider device 102b. Thus, the guest device 110 can transmit and receive data via the network 112a and over the connection between the provider device 102b and the intermediate device 102a, and the connection between the intermediate device 102a and the guest device 110.

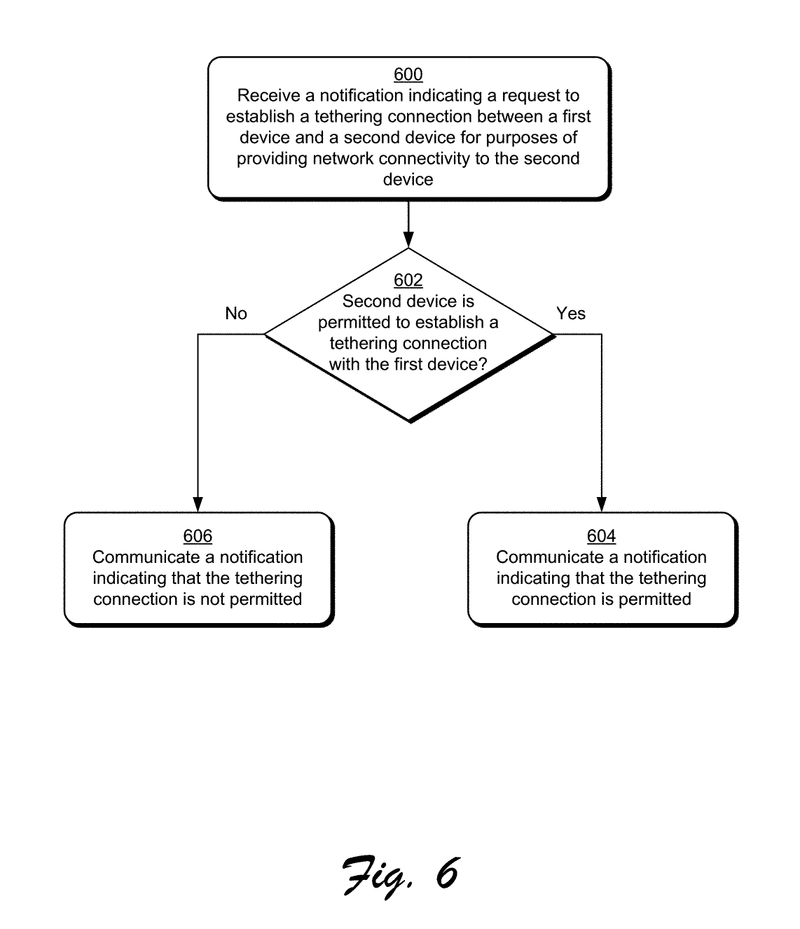

FIG. 6 is a flow diagram that describes steps in a method for determining parameters for a tethering connection in accordance with one or more implementations. In at least some implementations, the method can be performed by the tethering service 124 and/or interaction between the host device 102 and the tethering service 124.

Step 600 receives a notification indicating a request to establish a tethering connection between a first device and a second device for purposes of providing network connectivity to the second device. The tethering service 124, for instance, receives a notification from the intermediate device 102a indicating that the guest device 110 is requesting to tether to the intermediate device 102a for purposes of receiving network connectivity via the tethered connection.

Step 602 ascertains whether the second device is permitted to establish a tethering connection with the first device. In at least some implementations, the tethering service 124 applies a service policy 126 to ascertain whether the guest device 110 is permitted to establish a tethering connection with the intermediate device 102a. Various considerations for allowing or denying a tethering connection are discussed above.

If the second device is permitted to establish a tethering connection with the first device (“Yes”), step 604 communicates a notification indicating that the tethering connection is permitted. The tethering service 124, for instance, communicates the notification to the intermediate device 102a. Generally, the notification is effective to cause a tethering connection between the first device and the second device to be established and network connectivity to be provided to the second device via the tethering connection. As detailed throughout, network connectivity is provided subject to a tethering policy for providing network connectivity to the second device. The tethering service 124, for instance, communicates a service policy 126 to the intermediate device 102a to be applied for providing network connectivity to the guest device 110.

If the second device is not permitted to establish a tethering connection with the first device (“No”), step 606 communicates a notification indicating that the tethering connection is not permitted. For example, the tethering service 124 determines that the guest device 110 is not permitted to tether to the intermediate device 102a, and communicates a notification to the intermediate device 102a indicating that the tethering is not permitted.

A particular service policy 126, for instance, indicates that based on one or more conditions, tethering the guest device 110 to the intermediate device 102a is not permitted. Examples of such conditions include an indication that the intermediate device 102a is unknown or untrusted, and/or the network 112a to which the intermediate device 102a is connected is unknown or untrusted. According to various implementations, the intermediate device 102a denies the request from the guest device 110 to tether to the intermediate device 102a.

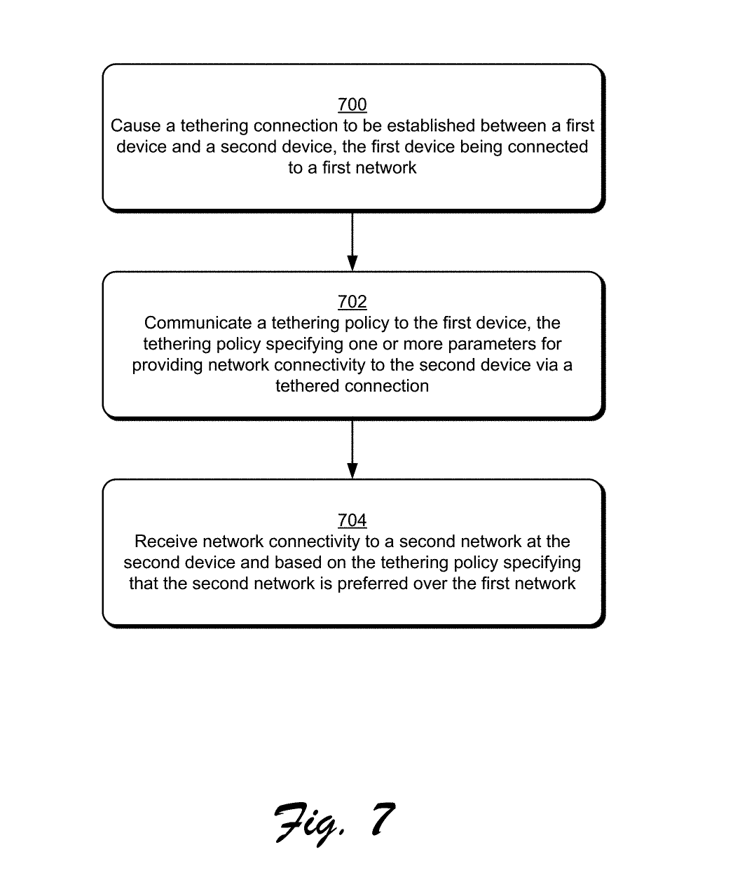

FIG. 7 is a flow diagram that describes steps in a method for brokering network connectivity via a tethering connection in accordance with one or more implementations. In at least some implementations, the method can be performed by the guest device 110.

Step 700 causes a tethering connection to be established between a first device and a second device, the first device being connected to a first network. The guest device 110, for instance, requests and negotiates a direct peer-to-peer connection with the intermediate device 102a while the intermediate device 102a is connected to the network 112a.

Step 702 communicates a tethering policy to the first device, the tethering policy specifying one or more parameters for providing network connectivity to the second device via a tethered connection. For example, the guest device 110 communicates a client policy 116 to the intermediate device 102a to be applied in providing network connectivity to the guest device 110.

Step 704 receives network connectivity to a second network at the second device and based on the tethering policy specifying that the second network is preferred over the first network. Generally, the network connectivity is implemented via connectivity of a third device to the second network, and connectivity of the first device to the third device.

As discussed above, for instance, the intermediate device 102a applies a host policy 108 to determine that the network 112b is preferred over the network 112a, and/or that the network 112a is a disallowed network. Accordingly, the intermediate device 102a brokers a connection to the provider device 102b such that the guest device 110 can transmit and receive data over the network 112b via the tethered connection between the guest device 110 and the intermediate device 102a, and the connection between the intermediate device 102a and the provider device 102b.

In at least some implementations, the guest device 110 applies one or more client policies 116 as part of its connectivity relationship with the intermediate device 102a and indirectly with the provider device 102b. For instance, a client policy 116 specifies a particular security procedure to be applied to data transmitted via the tethered connection, such as a particular encryption technique and/or protocol.

Accordingly, techniques for tethering policy for network connectivity via a tethered connection described herein enable a device without direct network connectivity to obtain indirect network connectivity from other devices in proximity. Further, various policies can be applied to specify how such indirect network connectivity is to be established and managed. Such policies can be leveraged for various purposes, such as to enhance quality of experience, device security, and data security over an indirect network connection.

Having discussed some example procedures, consider now a discussion of an example system and device in accordance with one or more embodiments.

### Example System and Device

FIG. 8 illustrates an example system generally at 800 that includes an example computing device 802 that is representative of one or more computing systems and/or devices that may implement various techniques described herein. For example, the host device 102 and/or the guest device 110 discussed above with reference to FIG. 1 can be embodied as the computing device 802. The computing device 802 may be, for example, a server of a service provider, a device associated with the client (e.g., a client device), an on-chip system, and/or any other suitable computing device or computing system.

The example computing device 802 as illustrated includes a processing system 804, one or more computer-readable media 806, and one or more I/O Interfaces 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 806 is illustrated as including memory/storage 812. The memory/storage 812 represents memory/storage capacity associated with one or more computer-readable media. The memory/storage 812 may include volatile media (such as random access memory (RAM)) and/or nonvolatile media (such as read only memory (ROM), Flash memory, optical disks, magnetic disks, and so forth). The memory/storage 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone (e.g., for implementing voice and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of modules as a module that is executable by the computing device 802 as software may be achieved at least partially in hardware, e.g., through use of computer-readable storage media and/or hardware elements 810 of the processing system. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for a seamless user experience when running applications on a personal computer (PC), a television device, and/or a mobile device. Services and applications run substantially similarly in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 802 may assume a variety of different configurations, such as for computer 814, mobile 816, and television 818 uses. Each of these configurations includes devices that may have generally different constructs and capabilities, and thus the computing device 802 may be configured according to one or more of the different device classes. For instance, the computing device 802 may be implemented as the computer 814 class of a device that includes a personal computer, desktop computer, a multi-screen computer, laptop computer, netbook, and so on.

The computing device 802 may also be implemented as the mobile 816 class of device that includes mobile devices, such as a mobile phone, a wearable device, portable music player, portable gaming device, a tablet computer, a multi-screen computer, and so on. The computing device 802 may also be implemented as the television 818 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein. For example, functionalities discussed with reference to the host device 102, the guest device 110, and/or the tethering service 124 may be implemented all or in part through use of a distributed system, such as over a “cloud” 820 via a platform 822 as described below.

The cloud 820 includes and/or is representative of a platform 822 for resources 824. The platform 822 abstracts underlying functionality of hardware (e.g., servers) and software resources of the cloud 820. The resources 824 may include applications and/or data that can be utilized while computer processing is executed on servers that are remote from the computing device 802. Resources 824 can also include services provided over the Internet and/or through a subscriber network, such as a cellular or Wi-Fi™ network.

The platform 822 may abstract resources and functions to connect the computing device 802 with other computing devices. The platform 822 may also serve to abstract scaling of resources to provide a corresponding level of scale to encountered demand for the resources 824 that are implemented via the platform 822. Accordingly, in an interconnected device embodiment, implementation of functionality described herein may be distributed throughout the system 800. For example, the functionality may be implemented in part on the computing device 802 as well as via the platform 822 that abstracts the functionality of the cloud 820.

Discussed herein are a number of methods that may be implemented to perform techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Implementations discussed herein include:

### Example 1

A system for enabling device connectivity to a network via a tethered connection, the system including: one or more processors; and one or more computer-readable storage media storing computer-executable instructions that are executable by the one or more processors to perform operations including: receiving a request to establish a tethering connection between a first device and a second device for purposes of providing network connectivity to the second device, the first device being connected to a first network; causing a tethered connection to be established between the first device and the second device; ascertaining based on a tethering policy that network connectivity for the second device is to be provided by a third device connected to a second network different than the first network; and causing a connection to be established between the first device and the third device to cause the second device to be connected to the second network via the tethered connection between the first device and the second device, and the connection between the first device and the third device.

### Example 2

A system as described in example 1, wherein said causing includes: querying a tethering service with an indication that the second device is requesting to tether to the first device; and receiving a notification from the tethering service indicating that the second device is permitted to tether to the first device.

### Example 3

A system as described in one or more of examples 1 or 2, further including receiving the tethering policy in conjunction with the request to establish a tethering connection.

### Example 4

A system as described in one or more of examples 1-3, further including receiving the tethering policy from the second device, and applying the tethering policy at the first device.

### Example 5

A system as described in one or more of examples 1-4, further including receiving the tethering policy from a cloud-based tethering service, and applying the tethering policy at the first device.

### Example 6

A system as described in one or more of examples 1-5, wherein the tethering policy specifies that the second network is preferred over the first network.

### Example 7

A system as described in one or more of examples 1-6, wherein the tethering policy specifies that the first network is a disallowed network for providing network connectivity to the second device.

### Example 8

A system as described in one or more of examples 1-7, wherein the tethering policy specifies a security procedure to be implemented by one or more of the first device or the second device for communicating data from the second device over the second network.

### Example 9

A system as described in one or more of examples 1-8, wherein the tethering policy specifies encryption to be applied by one or more of the first device or the second device for communicating data from the second device over the second network.

### Example 10

A computer-implemented method for enabling device connectivity to a network via a tethered connection, the method including: receiving a notification indicating a request to establish a tethering connection between a first device and a second device for purposes of providing network connectivity to the second device; ascertaining whether the second device is permitted to establish a tethering connection with the first device; and responsive to ascertaining that the second device is permitted to establish a tethering connection with the first device, communicating a notification indicating that the tethering connection is permitted, the notification being effective to cause the tethering connection between the first device and the second device to be established and network connectivity to be provided to the second device via the tethering connection and subject to a tethering policy for providing network connectivity to the second device.

### Example 11

A computer-implemented method as recited in example 10, wherein said receiving and said ascertaining are performed at a network service remote from the first device and the second device.

### Example 12

A computer-implemented method as recited in one or more of examples 10 or 11, wherein said ascertaining is based on one or more of an identity of the first device or a device type of the first device.

### Example 13

A computer-implemented method as recited in one or more of examples 10-12, wherein said ascertaining is based on one or more of a network identity or a network type of a network to which the first device is connected.

### Example 14

A computer-implemented method as recited in one or more of examples 10-13, further including communicating the tethering policy to the first device.

### Example 15

A computer-implemented method as recited in one or more of examples 10-14, wherein the tethering policy specifies one or more preferred networks for providing the network connectivity.

### Example 16

A computer-implemented method as recited in one or more of examples 10-15, wherein the tethering policy specifies one or more disallowed networks for providing the network connectivity.

### Example 17

A computer-implemented method as recited in one or more of examples 10-16, wherein the tethering policy specifies a security procedure to be implemented for data transmitted from the second device over the tethering connection.

### Example 18

A computer-implemented method for enabling device connectivity to a network via a tethered connection, the method including: causing a tethering connection to be established between a first device and a second device, the first device being connected to a first network; communicating a tethering policy to the first device, the tethering policy specifying one or more parameters for providing network connectivity to the second device via a tethered connection; and receiving network connectivity to a second network at the second device and based on the tethering policy specifying that the second network is preferred over the first network, the network connectivity being implemented via connectivity of a third device to the second network, and connectivity of the first device to the third device.

### Example 19

A computer-implemented method as recited in example 18, wherein said communicating includes communicating the tethering policy from the second device to the first device.

### Example 20

A computer-implemented method as recited in one or more of examples 18 or 19, wherein the tethering policy specifies that the second network is preferred over the first network for providing network connectivity to the tethered device.

### CONCLUSION

Techniques for tethering policy for network connectivity via a tethered connection are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
one or more processors; and
one or more computer-readable storage media storing computer-executable instructions that are executable by the one or more processors to perform operations including:
receiving a request to establish a tethering connection between a first device and a second device for purposes of providing network connectivity to the second device, the first device being connected to a first network;
causing a tethered connection to be established between the first device and the second device;
ascertaining based on a tethering policy that network connectivity for the second device is to be provided by a third device connected to a second network different than the first network; and
causing a connection to be established between the first device and the third device to cause the second device to be connected to the second network via the tethered connection between the first device and the second device, and the connection between the first device and the third device.

2. A system as described in claim 1, wherein said causing comprises:
querying a tethering service with an indication that the second device is requesting to tether to the first device; and
receiving a notification from the tethering service indicating that the second device is permitted to tether to the first device.

3. A system as described in claim 1, further comprising receiving the tethering policy in conjunction with the request to establish a tethering connection.

4. A system as described in claim 1, further comprising receiving the tethering policy from the second device, and applying the tethering policy at the first device.

5. A system as described in claim 1, further comprising receiving the tethering policy from a cloud-based tethering service, and applying the tethering policy at the first device.

6. A system as described in claim 1, wherein the tethering policy specifies that the second network is preferred over the first network.

7. A system as described in claim 1, wherein the tethering policy specifies that the first network is a disallowed network for providing network connectivity to the second device.

8. A system as described in claim 1, wherein the tethering policy specifies a security procedure to be implemented by one or more of the first device or the second device for communicating data from the second device over the second network.

9. A system as described in claim 1, wherein the tethering policy specifies encryption to be applied by one or more of the first device or the second device for communicating data from the second device over the second network.

10. A computer-implemented method comprising:
receiving a notification indicating a request to establish a tethering connection between a first device and a second device for purposes of providing network connectivity to the second device;
ascertaining whether the second device is permitted to establish a tethering connection with the first device; and
responsive to ascertaining that the second device is permitted to establish a tethering connection with the first device, communicating a notification indicating that the tethering connection is permitted, the notification being effective to cause the tethering connection between the first device and the second device to be established and network connectivity to be provided to the second device via the tethering connection and subject to a tethering policy for providing network connectivity to the second device.

11. A computer-implemented method as recited in claim 10, wherein said receiving and said ascertaining are performed at a network service remote from the first device and the second device.

12. A computer-implemented method as recited in claim 10, wherein said ascertaining is based on one or more of an identity of the first device or a device type of the first device.

13. A computer-implemented method as recited in claim 10, wherein said ascertaining is based on one or more of a network identity or a network type of a network to which the first device is connected.

14. A computer-implemented method as recited in claim 10, further comprising communicating the tethering policy to the first device.

15. A computer-implemented method as recited in claim 10, wherein the tethering policy specifies one or more preferred networks for providing the network connectivity.

16. A computer-implemented method as recited in claim 10, wherein the tethering policy specifies one or more disallowed networks for providing the network connectivity.

17. A computer-implemented method as recited in claim 10, wherein the tethering policy specifies a security procedure to be implemented for data transmitted from the second device over the tethering connection.

18. A computer-implemented method comprising:
causing a tethering connection to be established between a first device and a second device, the first device being connected to a first network;
communicating a tethering policy to the first device, the tethering policy specifying one or more parameters for providing network connectivity to the second device via a tethered connection; and
receiving network connectivity to a second network at the second device and based on the tethering policy specifying that the second network is preferred over the first network, the network connectivity being implemented via connectivity of a third device to the second network, and connectivity of the first device to the third device.

19. A computer-implemented method as recited in claim 18, wherein said communicating comprises communicating the tethering policy from the second device to the first device.

20. A computer-implemented method as recited in claim 18, wherein the tethering policy specifies that the second network is preferred over the first network for providing network connectivity to the tethered device.
